(19) United States
(12) Patent Application Publication
(10) Pub. No.: US 2025/0149725 A1
(43) Pub. Date: May 8, 2025

(54) RECHARGEABLE BATTERY

(71) Applicant: SAMSUNG SDI CO., LTD., Yongin-si (KR)

(72) Inventors: Kyugil CHOI, Yongin-si (KR); Minyoung JANG, Yongin-si (KR); Hyun CHO, Yongin-si (KR)

(21) Appl. No.: 18/734,276

(22) Filed: Jun. 5, 2024

(30) Foreign Application Priority Data
Nov. 7, 2023 (KR) 10-2023-0152967

(51) Int. Cl. H01M 50/342; H01M 50/105; H01M 50/119; H01M 50/121; H01M 50/122; H01M 50/124; H01M 50/129

(52) U.S. Cl. CPC H01M 50/3425; H01M 50/105; H01M 50/119; H01M 50/121; H01M 50/122; H01M 50/1245; H01M 50/129; H01M 2200/20

(57) ABSTRACT

A rechargeable battery includes an electrode assembly, a case including a first sheet and a second sheet positioned on an upper side and a lower side of the electrode assembly along a thickness direction of the electrode assembly, respectively, the first sheet and the second sheet defining a receiving portion surrounding the electrode assembly and a sealing portion connected to an edge of the receiving portion, and a vent layer in the sealing portion at a bonding surface of the first sheet and the second sheet, the sealing portion being bent toward a side of the receiving portion, and the vent layer being in contact with a corner of the receiving portion and one end of the sealing portion.

### CROSS-REFERENCE TO RELATED APPLICATION

This application claims priority to and the benefit of Korean Patent Application No. 10-2023-0152967, filed at the Korean Intellectual Property Office on Nov. 7, 2023, the overall contents of which are incorporated herein by reference.

### BACKGROUND

### 1 Field

The present disclosure relates to a rechargeable battery. More particularly, the present disclosure relates to a pouch-type battery case of a rechargeable battery.

### 2. Description of the Related Art

Rechargeable batteries may be used for a variety of purposes, such as powering small electronic devices, e.g., mobile phones and laptop computers, and powering motors for transportation vehicles, e.g., electric vehicles and hybrid vehicles. In the case of the former, pouch-type rechargeable batteries may be used to miniaturize and slim small electronic devices.

The internal temperature and the internal pressure of the rechargeable battery may rise rapidly due to various reasons such as fast charge, internal short circuit, external impact, and exposure to high temperature environments. The rechargeable battery is equipped with a vent function that discharges internal gas under preset temperature and pressure conditions to prevent ignition or explosion due to temperature and pressure increases.

### SUMMARY

A rechargeable battery according to an embodiment includes an electrode assembly, a case, and a vent layer. The case includes a receiving portion surrounding the electrode assembly and a sealing portion connected to the edge of the receiving portion, and is formed of a first sheet and a second sheet positioned on the upper and lower sides of the electrode assembly along the thickness direction. The vent layer is provided in the sealing portion. The sealing portion is bent to face the side of the receiving portion. The vent layer is in contact with the corner of the receiving portion and one end of the sealing portion, and is positioned at the bonding surface of the first sheet and the second sheet.

The sealing portion may include a first portion facing the side of the receiving portion and a second portion extending outwardly from the first portion. The vent layer may be positioned on the bonding surface of the second portion. The vent layer may be positioned over the bonding surface of the second portion and a part of the bonding surface of the first portion, and may be in contact with a part of the edge of the receiving portion.

The electrode assembly may include a plurality of electrode tabs. The sealing portion may include a pair of first sealing portions positioned on both sides of the receiving portion and parallel to the plurality of electrode tabs. The pair of first sealing portions may each include the first portion and the second portion. The sealing portion may include a second sealing portion that intersects the pair of first sealing portions. The second portion may be bent inwardly and is in contact with the second sealing portion and the other side of the receiving portion connected to the second sealing portion.

The first sheet and the second sheet may each include a polymer layer, and the melting point of the vent layer may be lower than the melting point of the polymer layer. The vent layer may be composed of a cast polypropylene layer with a coating layer laminated on the outer surface. The melting point of the coating layer may be from 105° C. to 115° C.

The bonding strength of the vent layer for at least one of the first sheet and the second sheet may be lower than the bonding strength between the first sheet and the second sheet. The vent layer may be composed of a cast polypropylene layer mixed with one of a resin or a metal. The bonding strength of the vent layer may be from 0.5 kgf to 1.4 kgf.

A rechargeable battery according to another embodiment includes an electrode assembly, a case, and a vent layer. The case includes a receiving portion surrounding the electrode assembly and a sealing portion connected to the edge of the receiving portion, and is formed of a first sheet and a second sheet positioned on the upper and lower sides of the electrode assembly along the thickness direction. The vent layer is provided in the sealing portion. The sealing portion includes a first portion that faces one side of the receiving portion by bending, and a second portion that extends outwardly from the first portion and is folded inwardly to face the other side of the receiving portion. The vent layer is positioned on the bonding surface of the second portion.

The vent layer may be positioned over the overall bonding surface of the second portion and a part of the bonding surface of the first portion. The first sheet and the second sheet may each include a polymer layer. The vent layer may be composed of a cast polypropylene layer with a coating layer laminated on the outer surface, and the melting point of the coating layer may be lower than the melting point of the polymer layer.

The vent layer may be composed of a cast polypropylene layer mixed with one of a resin or a metal. The bonding strength of the vent layer for at least one of the first sheet and the second sheet may be lower than the bonding strength between the first sheet and the second sheet.

### BRIEF DESCRIPTION OF THE DRAWINGS

Features will become apparent to those of skill in the art by describing in detail exemplary embodiments with reference to the attached drawings, in which:

FIG. 1 is a perspective view of a rechargeable battery according to an embodiment.

FIG. 2 is a cross-sectional view of a rechargeable battery along line II-II in FIG. 1.

FIG. 3 is an enlarged view of an electrode assembly of the rechargeable battery in FIG. 2.

FIG. 4 is a view showing a state before bending of a first sealing portion of a rechargeable battery in FIG. 2.

FIG. 5 is a front view of a first sealing portion of a rechargeable battery in FIG. 1.

FIG. 6 is a plan view of a rechargeable battery of a state before bending a first sealing portion in FIG. 5.

FIG. 7 is a view of a first sealing portion viewed from a direction A in FIG. 5.

FIG. 8A and FIG. 8B are partial enlarged views of a first sealing portion and a vent layer in FIG. 7.

FIG. 9 is a front view of a first sealing portion of a rechargeable battery according to another embodiment.

FIG. 10 is a plan view of a rechargeable battery showing a state before a bending of a first sealing portion in FIG. 9.

FIG. 11 is a partial perspective view of a rechargeable battery according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

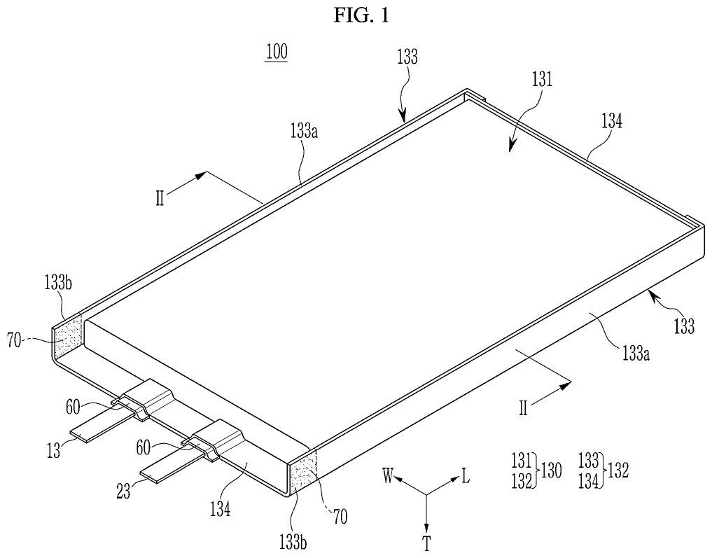

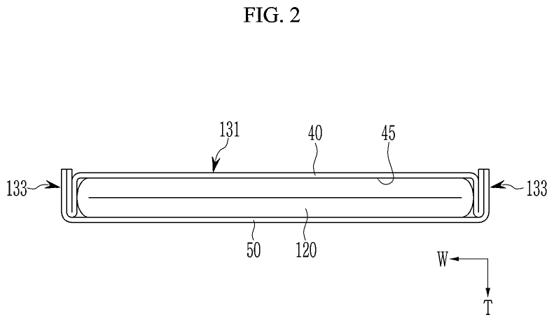

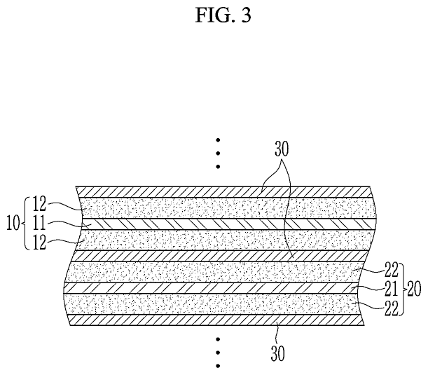

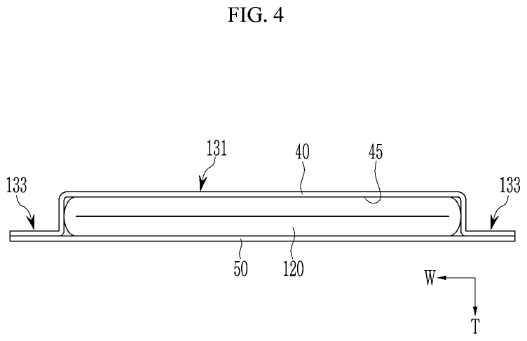

FIG. 1 is a perspective view of a rechargeable battery according to an embodiment. FIG. 2 is a cross-sectional view along line II-II in FIG. 1, and FIG. 3 is an enlarged view of an electrode assembly of the rechargeable battery in FIG. 2. FIG. 4 is a view of a state before bending of a first sealing portion of the rechargeable battery in FIG. 2.

Referring to FIG. 1 to FIG. 4, a rechargeable battery 100 of the present embodiment may include an electrode assembly 120 and a case 130 that accommodates and seals the electrode assembly 120 with an electrolyte. The case 130 may be referred to as a pouch and has a vent layer 70, which will be described later.

The electrode assembly 120 may include a first electrode 10 and a second electrode 20 positioned with a separator 30 therebetween. The first electrode 10 may include a first substrate 11, a first composite material layer 12 positioned on opposite surfaces (e.g., both surfaces) of the first substrate 11, and a first electrode tab 13 extending from the first substrate 11 to one side. The second electrode 20 may include a second substrate 21, a second composite material layer 22 positioned on opposite surfaces (e.g., both surfaces) of the second substrate 21, and a second electrode tab 23 extending from the second substrate 21 to one side (e.g. a same side as the first electrode tab 13).

In a lithium ion rechargeable battery, the first substrate 11 may be composed of, e.g., an aluminum foil, and the first composite material layer 12 may include a transition metal oxide, e.g., LiCoO₂, LiNiO₂, LiMn₂O₄, Li(NiCoAl)O₂, LiFePO₄, Li(NiCoMn)O₂, etc., a conductive material, and a binder, etc. The second substrate 21 may be composed of, e.g., a copper foil or a nickel foil, and the second composite material layer 22 may include graphite, a conductive material, and a binder, etc. For example, the first electrode 10 may be referred to as a positive electrode, and the second electrode 20 may be referred to as a negative electrode.

The separator 30 may include a polymer material, e.g., polyethylene (PE) or polypropylene (PP). The separator 30 may insulate the first electrode 10 and the second electrode 20 from each other while allowing a movement of lithium ions.

For example, the electrode assembly 120 may include a configuration in which the first electrode 10 and the second electrode 20 are wound around two winding axes and then pressed flatly (i.e., a wound type). In another example, the electrode assembly 120 may include a configuration in which a plurality of first electrodes 10 and a plurality of second electrodes 20 are alternately stacked one by one with the separator 30 therebetween (i.e., a stacked type). In the latter case, a plurality of individually separated separators may be used, or a single separator folded in a zigzag pattern may be used. FIG. 2 shows a case in which the electrode assembly 120 is a wound type as an example.

The electrode assembly 120 may have a rectangular shape having a pair of long sides and a pair of short sides on a plane (i.e., when a target object is viewed from above). Hereinafter, ‘on a plane’ means when the target object is viewed from above (i.e., a top view).

In the present embodiment, a direction parallel to the long side of the electrode assembly 120 is called a “length direction L” of the rechargeable battery, and a direction parallel to the short side of the electrode assembly 120 is called a “width direction W” of the rechargeable battery. Additionally, the direction orthogonal to the length direction L and the width direction W is called a “thickness direction T” of the rechargeable battery. The first electrode tab 13 and the second electrode tab 23 may extend from one short side of the electrode assembly 120 along the length direction L and may be positioned at a distance from each other along the width direction W.

The case 130 may include a first sheet 40 and a second sheet 50 positioned on both sides (e.g., upper and lower sides) of the electrode assembly 120 along the thickness direction T. The first sheet 40 and the second sheet 50 may each be composed of a composite sheet, and may each have an area larger than an area of the electrode assembly 120 on a plane. One of the first sheet 40 and the second sheet 50 (e.g., the first sheet 40) may be provided with a recess portion 45 capable of accommodating the electrode assembly 120 by drawing. For example, as illustrated in FIG. 4, the second sheet 50 may be flat, and the first sheet 40 may be bent (e.g., may include a portion curved away or bowing away from the second sheet 50) to define the recess portion 45 between the first and second sheets 40 and 50 to accommodate the electrode assembly 120 between the first and second sheets 40 and 50.

The composite sheet of each of the first sheet 40 and the second sheet 50 may have a three-layered structure of a polymer layer, a metal layer, and a polymer layer. The metal layer may include, e.g., aluminum, and may provide mechanical strength to the case 130. The polymer layer may include, e.g., any one of modified polypropylene (PP), polyethylene terephthalate (PET), nylon, and PET-nylon, and may provide insulation and protection to the case 130.

After the electrode assembly 120 is accommodated in the recess portion 45 of the first sheet 40, the edges of the first sheet 40 and the second sheet 50 may be integrally joined by thermal fusion (FIG. 4). The case 130 may include a receiving portion 131 that accommodates the electrode assembly 120, and a sealing portion 132 connected to the edge of the receiving portion 131. The central portion of the first and second sheets 40 and 50 surrounding the electrode assembly 120 may constitute the receiving portion 131, and the edge portions of the first and second sheets 40 and 50 joined together by thermal fusion may constitute the sealing portion 132. That is, the sealing portion 132 may be composed of a bonded body of the first sheet 40 and the second sheet 50 (e.g., edge portions of the first sheet 40 and the second sheet 50 that are in direct surface contact with each other and are directly bonded to each other).

The sealing portion 132 may include a pair of first sealing portions 133 parallel to the length direction L and a pair of second sealing portions 134 parallel to the width direction W. The first and second electrode tabs 13 and 23 may protrude to the outside of the case 130 through one of the second sealing portions 134 and may function as an electrode terminal that supplies a current to an external device. The first and second electrode tabs 13 and 23 may overlap the second sealing portion 134 in the portion surrounded by the protective tape 60.

As illustrated in FIG. 2, the first sealing portion 133 may be bent to face the side of the receiving portion 131 to reduce the overall size of the rechargeable battery 100. The initial first sealing portion 133, as shown in FIG. 4, may be arranged parallel to the upper and lower surfaces of the electrode assembly 120, which enlarges the overall size of the rechargeable battery. In order to downsize the electronic device, the overall size of the rechargeable battery 100 may be reduced by bending the first sealing portion 133 toward the receiving portion 131 (e.g., to directly contact and be flat against a lateral side of the receiving portion 131), so the bent first sealing portion 133 may be positioned parallel to the side (e.g., parallel to the lateral side) of the receiving portion 131.

If the recess portion 45 is provided on the first sheet 40, the first sealing portion 133 before bending may be positioned at substantially the same height as the second sheet 50 (e.g., a bottom of the second sheet 50 in the receiving portion 131 may be coplanar with a bottom of the second sheet 50 in the unbent first sealing portion 133). After bending the first sealing portion 133, the first sealing portion 133 may be bent vertically upward with reference to FIG. 4 and positioned parallel to the lateral side of the electrode assembly 120.

Referring to FIG. 1, among the pair of second sealing portions 134, one of the pair of the second sealing portions 134 may be positioned at a same side as the first and second electrode tabs 13 and 23, as described previously. Another of the pair of the second sealing portions 134 may be positioned on a side opposite to the first and second electrode tabs 13 and 23, and may be vertically bent to face the side of the receiving portion 131, like the first sealing portion 133.

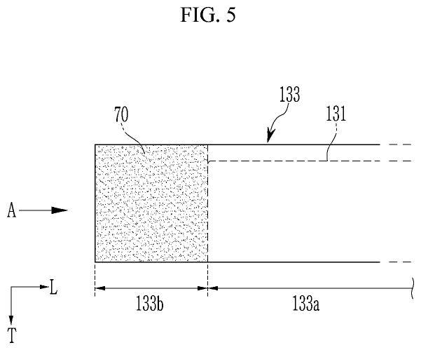

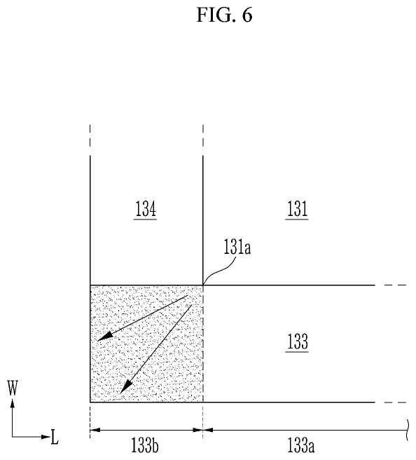

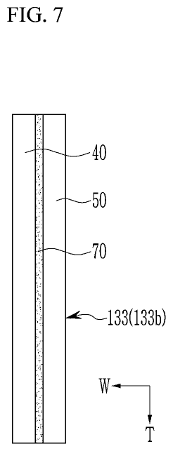

FIG. 5 is a front view of the first sealing portion 133 of the rechargeable battery 100 shown in FIG. 1, and FIG. 6 is a plan view of the rechargeable battery 100 before bending the first sealing portion 133 shown in FIG. 5. FIG. 7 is a view of the first sealing portion 133 viewed from a direction A in FIG. 5.

Referring to FIG. 1 and FIGS. 5-7, the length of the first sealing portion 133 along the length direction L may be greater than the length of the receiving portion 131. One end of the first sealing portion 133 (e.g., the left end with reference to FIG. 5) may be positioned at a distance from the receiving portion 131 along the length direction L. For example, referring to FIG. 1, an end of the first sealing portion 133 that includes the vent layer 70 may extend beyond the receiving portion 131 along the length direction L. The first sealing portion 133 may include a first portion 133a that faces the receiving portion 131 along the width direction (e.g., the first portion 133a may face and overlap the receiving portion 131 in the width direction W), and a second portion 133b that does not face the receiving portion 131 along the width direction W (e.g., the entirety of the second portion 133b may have a non-overlapping relationship with the receiving portion 131 in the width direction W). The second portion 133b may be referred to as an extension portion.

The vent layer 70 may be positioned on the bonding surface of the second portion 133b so as to be in contact with an edge 131a of the receiving portion 131. The bonding surface of the second portion 133b is a bonding surface of the first sheet 40 and the second sheet 50, and the vent layer 70 may be positioned between the first sheet 40 and the second sheet 50 in the second portion 133b. For example, referring to FIG. 6, before bending the first sealing portion 133 toward the receiving portion 131, the vent layer 70 may be positioned between the first sheet 40 and the second sheet 50 in the second portion 133b (e.g., only in the second portion 133b among the first and second portions 133a and 133b), such that a corner of the vent layer 70 and the edge 131a of the receiving portion 131 may contact each other. For example, referring to FIG. 1, after bending the first sealing portion 133 toward the receiving portion 131, the vent layer 70 (that extends beyond the first portion 133a of the first sealing portion 133) may be bent with the first sealing portion 133 toward the receiving portion 131 (e.g., without overlapping the first sealing portion 133 in the width direction W).

During manufacturing of the first sheet 40 and the second sheet 50, the vent layer 70 may be provided on at least one of the inner surfaces of the first sheet 40 and the inner surface of the second sheet 50 corresponding to the second portion 133b. The vent layer 70 may be joined to at least one of the inner surfaces of the first and second sheets 40 and 50 by any suitable method, e.g., adhesive bonding, heat fusion, or welding. The vent layer 70 may be positioned over all the bonding surface of the second portion 133b (e.g., the vent layer 70 may cover and overlap the entirety of the bonding surface of the second portion 133b).

The vent layer 70 may have a bonding degree (e.g., a bonding level) lower than the bonding degree between the first sheet 40 and the second sheet 50 due to thermal fusion, or may have a melting point lower than the melting point of the polymer layer of the first and second sheets 40 and 50. For example, the vent layer 70 may simultaneously have a bonding degree lower than the bonding degree between the first sheet 40 and the second sheet 50 and a melting point lower than the melting point of the polymer layers of the first and second sheets 40 and 50.

Herein, the bonding degree of the vent layer 70 refers to the bonding degree of the vent layer 70 with respect to the first sheet 40 or the second sheet 50, or refers to the bonding degree between two vent layers 70 (e.g., if one vent layer 70 is positioned on each of the inner surface of the first sheet 40 and the inner surface of the second sheet 50, and the two vent layers 70 are mutually joined to each other between the inner surfaces of the first and second sheets 40 and 50). The bonding degree may have the same meaning as a bonding strength. The vent layer 70 may be composed of one of a polymer resin layer or a polymer resin-metal mixed layer that satisfies the above-mentioned conditions.

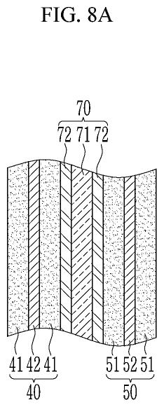

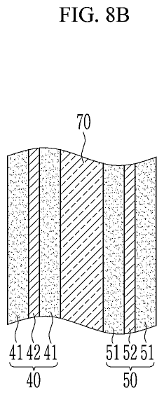

FIG. 8A and FIG. 8B are enlarged views of a first sealing portion and a vent layer shown in FIG. 7.

For example, referring to FIG. 8A, the vent layer 70 may include a cast polypropylene (CPP) layer 71 and a coating layer 72 positioned on the outer surface of the cast polypropylene layer 71, e.g., the cast polypropylene (CPP) layer 71 may be between two coating layers 72. The coating layer 72 may be a resin layer including polyethylene (PE), or a metal layer including aluminum (Al) or copper (Cu). The melting point of the coating layer 72 may be approximately 100° C. to 120° C., e.g., approximately 105° C. to 115° C. This melting point of the coating layer 72 may be lower than the melting point of polymer layers 41 and 51 of the first and second sheets 40 and 50, which range from approximately 140° C. to 165° C.

In another example, referring to FIG. 8B, the vent layer 70 may be composed of the cast polypropylene (CPP) layer mixed with resin, e.g., polyethylene (PE), and/or with a metal, e.g., aluminum (Al) or copper (Cu). For example, as illustrated in FIG. 8B, the vent layer 70 may include resin and/or metal mixed inside the cast polypropylene layer into a single layer. The first and second sheets 40 and 50 may be joined at a temperature of approximately 180° C. to 230° C. and a time condition of 1 second to 5 seconds. In this case, the bonding strength between the first sheet 40 and the second sheet 50 may be approximately 1.5 kgf or more. The bonding strength of the vent layer 70 may be approximately 0.5 kgf to 1.4 kgf, which is lower than the bonding strength between the first sheet 40 and the second sheet 50.

In general, an internal temperature of the rechargeable battery may rise due to various reasons, e.g., a fast charge, an internal short circuit, an external impact, or exposure to a high temperature environment. If the internal temperature of the rechargeable battery rises above a predetermined temperature, a gas may be generated due to a gasification of the electrolyte solution. The gas generation may lead to an increase in the internal pressure of the rechargeable battery, which may cause ignition and explosion of the rechargeable battery.

According to example embodiments, referring to FIG. 5 to FIG. 7, the vent layer 70 may be fused (e.g., melted) under a specific temperature condition to open the bonding surface, or the bonding of the vent layer 70 may be released under specific pressure conditions to open the bonding surface. For example, above the specific temperature, the surface of the vent layer 70 (e.g., the coating layer 72 in FIG. 8A) may be fused (e.g., melted), thereby generating a gap between the first and second sheets 40 and 50 (e.g., in place of the melted vent layer 70 or between the vent layer 70 and at least one of the first and second sheets 40 and 50). In another example, under specific pressure conditions (i.e., if the pressure applied to the vent layer 70 becomes greater than the bonding degree of the vent layer 70), the vent layer 70 may be torn from the first and second sheets 40 and 50, or the vent layer 70 may be destroyed, thereby forming a gap between the first and second sheets 40 and 50, a gap between the vent layer 70 and at least one of the first and second sheets 40 and 50, and/or a gap inside the vent layer 70.

The internal gas of the rechargeable battery 100 may reach the edge of the vent layer 70 from the edge 131a of the receiving portion 131 through the gap formed around the vent layer 70 or inside the vent layer 70, and may be quickly discharged to the outside through the opened bonding surface. In FIG. 6, the direction of the movement of the internal gas across the vent layer 70 is indicated by an arrow. In this way, the vent layer 70 relieves the internal pressure by opening the bonding surface if the internal pressure of the rechargeable battery 100 increases.

The rechargeable battery 100 of the present embodiment may reduce its overall size by bending the first sealing portion 133. Further, the rechargeable battery 100 may effectively prevent ignition and explosion by quickly relieving the internal pressure by using the vent layer 70 if the internal pressure rises.

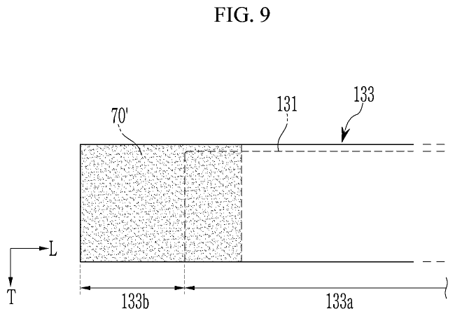

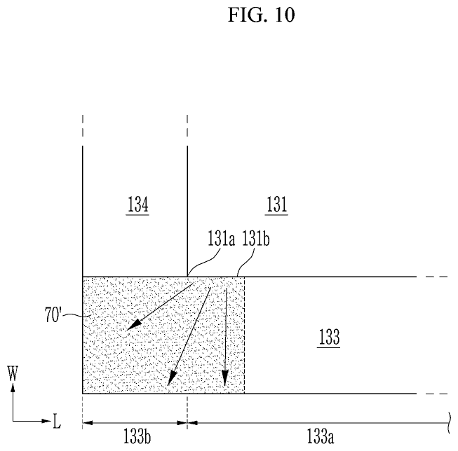

FIG. 9 is a front view of a first sealing portion of a rechargeable battery according to another embodiment. FIG. 10 is a plan view of a rechargeable battery showing a state before bending of a first sealing portion shown in FIG. 9. The rechargeable battery of in FIGS. 9-10 has the same or a similar configuration as the embodiment described above with reference to FIGS. 1-8B, except for the structure of the vent layer.

Referring to FIG. 9 and FIG. 10, a vent layer 70′ may be positioned over the overall bonding surface of the second portion 133b and a part of the bonding surface of the first portion 133a. A part of the vent layer 70′ may face the side of the receiving portion 131 along the width direction W. The vent layer 70′ may be in contact with not only the edge 131a of the receiving portion 131 but also with a part of an edge 131b of the receiving portion 131 parallel to the length direction L.

In FIGS. 9-10, as the length of the vent layer 70′ in contact with the receiving portion 131 is extended (e.g., compared to FIGS. 5-6), the opening of the bonding surface of the vent layer 70 and the resulting gas discharge may be performed more smoothly if the temperature and the pressure of the rechargeable battery rise. In FIG. 10, the direction of the movement of the internal gas across the vent layer 70′ is indicated by an arrow.

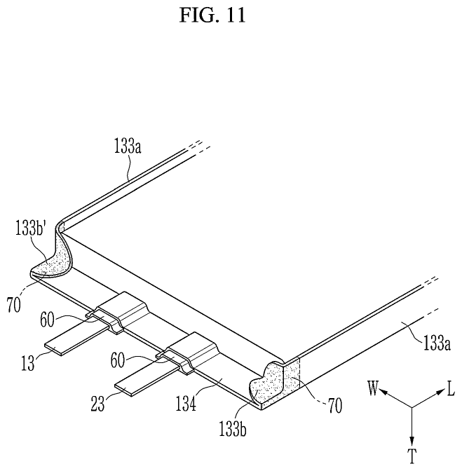

FIG. 11 is a partial perspective view of a rechargeable battery according to another embodiment. The rechargeable battery in FIG. 11 has the same or a similar configuration as any of the embodiments described above with reference to FIGS. 1-10, except for a second portion of the first sealing portion 133.

Referring to FIG. 11, a second portion 133b′ of the first sealing portion 133 may be positioned with an inward bend. A part of the bent second portion 133b′ may be in contact with the upper surface of the second sealing portion 134, and the remainder of the bent second portion 133b′ may be in contact with the side surface of the receiving portion 131 connected to the second sealing portion 134. The bent second portion 133b has a shape similar to a dog's ear, so it may be referred to as a dog-ear portion.

For example, the vent layer 70 may be positioned on the overall bonding surface of the second portion 133b′ while being in contact with the edge 131a of the receiving portion 131 (referring to FIG. 6). In another example, as illustrated in FIG. 11, the vent layer 70 may be positioned over the overall bonding surface of the second portion 133b and over a part of the bonding surface of the first portion 133a while being in contact with the edge 131a of the receiving portion 131 and with a part of the edge 131b of the receiving portion 131 (referring to FIG. 10).

In the structure where the second portion 133b′ of the first sealing portion 133 is folded inward, since the portion protruding to the outside of the receiving portion 131 may be minimized, if a protective circuit (e.g., a protection circuit module (PCM)) is combined on the case 130, the combination of the case 130 and the protective circuit may be facilitated.

In an abnormal situation, if the internal pressure of the rechargeable battery increases, the pressure is concentrated on the vent layer 70, which has a relatively weak bonding degree, and the second portion 133b′, which was folded due to the concentrated pressure, may unfold to be parallel to the first portion 133a. After the second portion 133b′ is unfolded, the bonding surface may be opened as the surface of the vent layer 70 is fused (e.g., melted) due to the increase in temperature, and/or the bonding surface may be opened as the vent layer 70 may be torn or destroyed due to the increase in pressure. That is, the second portion 133b′ may be expanded due to the increase in the primary pressure, and the bonding surface may be opened due to the increase in temperature and the secondary pressure, thereby relieving the internal pressure and improving the safety of the rechargeable battery.

By way of summation and review, example embodiments provide a rechargeable battery that may easily discharge internal gas under predetermined temperature and pressure conditions by having a vent function optimized for a sealing structure of a pouch-type rechargeable battery. That is, the rechargeable battery according to the embodiments may reduce the overall size by bending the sealing portion, and may prevent ignition and explosion, as well as improve safety, by quickly relieving the internal pressure using a vent layer provided in the sealing portion if the internal pressure increases.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly;
a case including a first sheet and a second sheet positioned on an upper side and a lower side of the electrode assembly along a thickness direction of the electrode assembly, respectively, the first sheet and the second sheet defining a receiving portion surrounding the electrode assembly and a sealing portion connected to an edge of the receiving portion; and
a vent layer in the sealing portion at a bonding surface of the first sheet and the second sheet, the sealing portion being bent toward a side of the receiving portion, and the vent layer being in contact with a corner of the receiving portion and one end of the sealing portion.

2. The rechargeable battery as claimed in claim 1, wherein:
the sealing portion includes a first portion facing the side of the receiving portion and a second portion extending outwardly from the first portion, and
the vent layer is positioned on a bonding surface of the second portion.

3. The rechargeable battery as claimed in claim 2, wherein the vent layer is positioned over the bonding surface of the second portion and over a part of a bonding surface of the first portion, the vent layer being in contact with a part of the edge of the receiving portion.

4. The rechargeable battery as claimed in claim 2, wherein:
the electrode assembly includes a plurality of electrode tabs,
the sealing portion includes a pair of first sealing portions positioned on opposite sides of the receiving portion and parallel to the plurality of electrode tabs, and
each of the pair of first sealing portions includes the first portion and the second portion.

5. The rechargeable battery as claimed in claim 4, wherein:
the sealing portion includes a second sealing portion that intersects the pair of first sealing portions, and
the second portion is bent inwardly and is in contact with the second sealing portion and the side of the receiving portion connected to the second sealing portion.

6. The rechargeable battery as claimed in claim 1, wherein:
each of the first sheet and the second sheet includes a polymer layer, and
a melting point of the vent layer is lower than a melting point of the polymer layer.

7. The rechargeable battery as claimed in claim 6, wherein the vent layer is composed of a cast polypropylene layer with a coating layer laminated on an outer surface of the cast polypropylene layer.

8. The rechargeable battery as claimed in claim 7, wherein the melting point of the coating layer is 105° C. to 115° C.

9. The rechargeable battery as claimed in claim 1, wherein a bonding strength of the vent layer with respect to at least one of the first sheet and the second sheet is lower than a bonding strength between the first sheet and the second sheet.

10. The rechargeable battery as claimed in claim 9, wherein the vent layer is composed of a cast polypropylene layer mixed with one of a resin or a metal.

11. The rechargeable battery as claimed in claim 10, wherein the bonding strength of the vent layer is 0.5 kgf to 1.4 kgf.

12. A rechargeable battery, comprising:
an electrode assembly;
a case including a first sheet and a second sheet positioned on an upper side and a lower side of the electrode assembly along a thickness direction of the electrode assembly, respectively, the first sheet and the second sheet defining a receiving portion surrounding the electrode assembly and a sealing portion connected to an edge of the receiving portion, and the sealing portion including a first portion facing and bent toward a side of the receiving portion, and a second portion extending outwardly from the first portion and being folded inwardly to face another side of the receiving portion; and
a vent layer in the sealing portion and positioned on a bonding surface of the second portion.

13. The rechargeable battery as claimed in claim 12, wherein the vent layer is positioned over an overall bonding surface of the second portion and over a part of a bonding surface of the first portion.

14. The rechargeable battery as claimed in claim 12, wherein:
each of the first sheet and the second sheet includes a polymer layer,
the vent layer is composed of a cast polypropylene layer with a coating layer laminated on an outer surface of the cast polypropylene layer, and
a melting point of the coating layer is lower than a melting point of the polymer layer.

15. The rechargeable battery as claimed in claim 12, wherein:
the vent layer is composed of a cast polypropylene layer mixed with one of a resin or a metal, and
a bonding strength of the vent layer with respect to at least one of the first sheet and the second sheet is lower than a bonding strength between the first sheet and the second sheet.
